(19) United States
(12) Patent Application Publication
(10) Pub. No.: US 2009/0133408 A1
(43) Pub. Date: May 28, 2009

(54) Re-pressurisation device

(75) Inventor: Daniel Robertson, Derby (GB)

Correspondence Address: OLIFF & BERRIDGE, PLC, P.O. BOX 320850, ALEXANDRIA, VA, 22320-4850, US

(73) Assignee: ROLLS-ROYCE PLC, London (GB)

(21) Appl. No.: 12/081,655

(22) Filed: Apr. 18, 2008

(30) Foreign Application Priority Data
May 10, 2007 (GB) 0708964.2

(51) Int. Cl. F02C 9/18

(52) U.S. Cl. 60/785

(57) ABSTRACT

A gas turbine engine re-pressurisation device (36) for cooled cooling fluid, the re-pressurisation device (36) comprising a compressor stage (42) and a turbine stage (46), characterised in that a common mounting means (58) is provided between the compressor stage (42) and the turbine stage (46) such that one of the compressor stage (42) and the turbine stage (46) is located radially inwardly of the other, the re-pressurisation device (36) further comprising fluid flow directing means (44) to direct a first portion of the fluid (40) through the compressor stage (42) and a second portion (54) through the turbine stage (46).

The present invention relates to re-pressurisation of cooling fluid and is particularly applicable to the re-pressurisation of cooled cooling fluid. It is described herein with reference to gas turbine engine applications but may equally be incorporated into air conditioning systems or combined cycle power generation.

With respect to a gas turbine application, it is well known in the art to extract a portion of cooling fluid from a cool part of the engine, for example a compressor stage, in order to cool a hot part, for example a turbine stage. It is also known to pressurise this cooling fluid flow before supplying it to at least some hot parts of the engine. For example, EP 1,033,484 B1 describes the extraction of a portion of cooling air from the exit of a high pressure (HP) compressor of a gas turbine engine, whereupon it is cooled and then passed through a compressor comprising in axial flow series a stator, a rotor and a second stator. The cooling air then passes through the nozzle guide vanes (NGVs) of the engine into a second heat exchanger, back through the NGVs, into the high pressure turbine and finally is exhausted into the combustor exit flow via the NGVs again.

One disadvantage of this method is that there is a considerable weight penalty associated with the additional components. Due to the arrangement of the components two heat exchangers are required. Since the cooling fluid travels through the NGVs and thereby picks up additional heat from the main combustor exhaust flow, the second of these heat exchangers is required to do more work and therefore is, of necessity, larger than in other arrangements.

A further disadvantage of the method is the multiple flow directions of cooling air through the NGVs. This increases the complexity of the NGVs, as the flows must be kept separate, which produces a consequent sealing problem. Some heat exchange will take place uncontrolledly within the passages of the NGVs, as well as between the cooling air and the combustor exhaust flow detailed above.

A second conventional method of re-pressurising cooling fluid in a gas turbine engine is described, for example, in U.S. Pat. No. 5,392,614. Cooling air is extracted from, for example, the exit of a low pressure (LP) compressor stage and is passed through a heat exchanger. It is then supplied to a compressor stage and from thence to a hot part of the engine, for example the HP turbine, for the purposes of cooling that part. The compressor stage is driven via a shaft connected to a turbine stage. The turbine stage receives higher pressure air than the compressor, for example extracted from the intermediate pressure compressor stage of the engine, and exhausts this to the bypass duct. Alternative arrangements are disclosed including first compressing and then cooling the cooling air flow.

One disadvantage of this method of re-pressurisation is that there is a weight penalty due to the shaft between the compressor and turbine stages. In one embodiment there are two heat exchangers, which further increases the weight penalty. There are other weight increases associated with the ducts required to extract cooling fluid and heat exchanger coolant from some parts of the engine and to deliver cooled cooling air to other parts.

It is known to provided nested compressor and turbine stages for the main flow of a gas turbine engine. The intake air first passes through a radially inner compressor stage and a combustor and is then directed radially outwardly, by baffles or similar devices, to pass in the opposite direction through a turbine stage before being exhausted.

One disadvantage of this design is that the air must reverse direction to pass through the turbine stage, which incurs friction losses and inefficiencies. It also increases the complexity and weight of the components to ensure that the air is correctly directed. A further disadvantage is that the hot turbine stage is located adjacent the cool compressor stage. Consequently heat will be transferred to the compressor air flow and the engine will be less efficient. Due to the proximity and arrangement of the components there is little scope to extract cooling fluid and supply it to hotter parts.

The present invention seeks to provide a novel re-pressurisation device which reduces, or preferably overcomes, the above mentioned problems.

Accordingly the present invention provides a re-pressurisation device for cooled cooling fluid, the re-pressurisation device comprising a compressor stage and a turbine stage, characterised in that a common mounting means is provided between the compressor stage and the turbine stage such that one of the compressor stage and the turbine stage is located radially inwardly of the other, the re-pressurisation device further comprising fluid flow directing means to direct a first portion of fluid through the compressor stage and a second portion through the turbine stage.

Preferably, the turbine stage comprises at least one rotor stage comprising an annular array of rotor blades. More preferably, the turbine stage comprises at least one rotor stage and at least one stator stage comprising an annular array of stator vanes. More preferably, the turbine stage comprises rotor and stator stages in alternating relation.

Preferably, the compressor stage comprises at least one rotor stage comprising an annular array of rotor blades. More preferably, the compressor stage comprises at least one rotor stage and at least one stator stage comprising an annular array of stator vanes. More preferably, the compressor stage comprises rotor and stator stages in alternating relation.

The compressor stage may be a multi-stage compressor.

Preferably, the common mounting means is a disc or drum. Preferably, the common mounting means is located by at least one bearing. The bearing is one of the group comprising air bearings, electro-magnetic bearings and oil film bearings.

Preferably the compressor stage is located radially inwardly of the turbine stage.

The present invention also provides a gas turbine engine comprising a re-pressurisation device as previously described. Preferably, the gas turbine engine further comprises a heat exchanger upstream of the re-pressurisation device. Preferably the cooled cooling fluid is air extracted from a bypass duct of the gas turbine engine.

The present invention will be more fully described by way of example with reference to the accompanying drawings, in which:

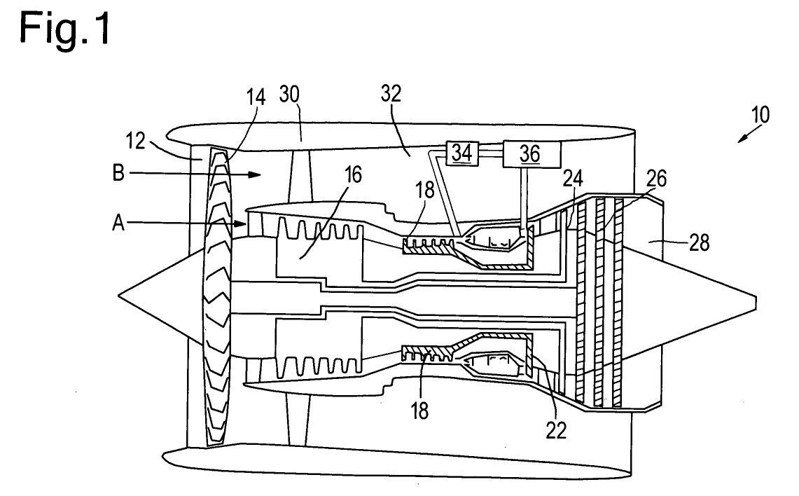

FIG. 1 is a sectional side view of a gas turbine engine that incorporates a re-pressurisation device in accordance with the present invention.

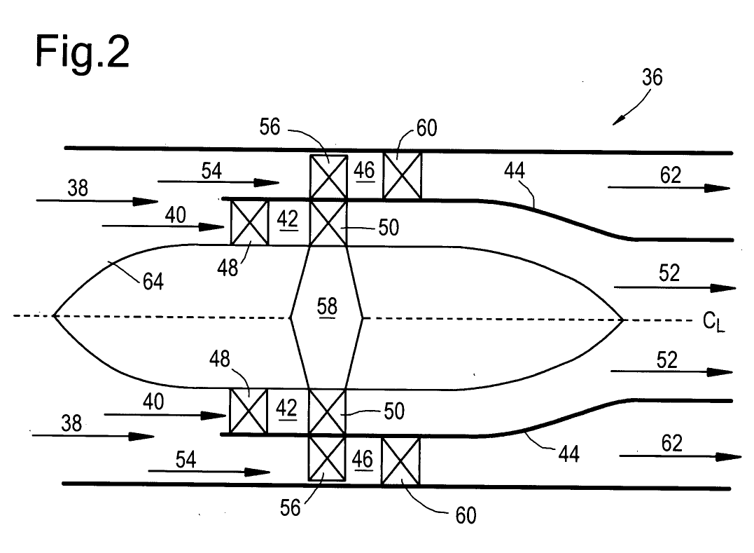

FIG. 2 is a schematic drawing of the re-pressurisation device of the gas turbine engine shown in FIG. 1.

A gas turbine engine 10 is shown in FIG. 1 and comprises an air intake 12 and a propulsive fan 14 that generates two airflows A and B. The gas turbine engine 10 comprises, in axial flow A, an intermediate pressure compressor 16, a high pressure compressor 18, a combustor 20, a high pressure turbine 22, an intermediate pressure turbine 24, a low pressure turbine 26 and an exhaust nozzle 28. A nacelle 30 surrounds the gas turbine engine 10 and defines, in axial flow B, a bypass duct 32. Air is extracted from a relatively cool part of the engine, in this particular case the exit of the high pressure compressor 18, and is supplied as a fluid to be cooled to one inlet of a heat exchanger 34. The heat exchanger 34 is located in the bypass duct 32 and coolant, in the form of cool air from the bypass duct 32, is passed through the heat exchanger 34 to cool the fluid to be cooled. The cooled cooling fluid is then supplied to a re-pressurisation device 36. Re-pressurised cooled cooling fluid exiting this device 36 is supplied to hot parts of the engine, for example the high pressure turbine 22, to provide cooling of those hot parts.

An exemplary embodiment of the re-pressurisation device 36 of the present invention is shown in FIG. 2. Cooled cooling fluid, in the form of air extracted from a cool part of the engine and cooled as described above, is supplied to the inlet of the re-pressurisation device 36 as indicated by arrows 38. A flow director 44, being substantially cylindrical and axially extending, is located within the re-pressurisation device 36. It is radially centred on a centre line CL of the re-pressurisation device 36 and defines two coaxial flow passages. The first flow passage is radially inwardly of the flow director 44 and a first portion 40 of the cooled air flow is directed through a compressor stage 42 within this flow passage. The second flow passage is radially outwardly of the flow director 44 and a turbine stage 46 is located within this flow passage.

The compressor stage 42 comprises an annular array of stator vanes 48 which direct the first portion of the air flow 40 to an annular array of rotor blades 50. The rotor blades 50 compress the air flow and thereby re-pressurise it to compensate for loss of pressure experienced through the heat exchanger 34. The re-pressurised cooled air flow 52 is exhausted into ducting (not shown) to hot parts of the engine to provide cooling.

The flow director 44 directs a second portion of the air flow 54 through the second flow passage towards the turbine stage 46. An annular array of rotor blades 56 is driven by the air flow 54. The rotor blades 56 have a common mounting 58 with the rotor blades 50 of the compressor stage 42. In this case, the common mounting 58 is a disc located with its centre on the centre line CL Of the re-pressurisation device 36. The compressor rotor blades 50 are mounted on the radially outer edge of the common mounting disc 58; the radially inner face of the flow director 44 is fixed to the radially outer edges of the compressor rotor blades 50; and the turbine rotor blades 56 are mounted on the radially outer face of the flow director 44. This is an advantageous arrangement since it obviates the requirement for a shaft to transfer the power generated by the turbine stage to the compressor stage with the consequent weight reduction compared to prior art arrangements. The air flow exiting the turbine rotor blades 56 is straightened by guide vanes 60 and then exhausted as cooled air flow 62. This can also be used to cool hot parts of the engine, and will preferably cool cooler parts than those cooled by the re-pressurised cooled air flow 52. For example, the re-pressurised cooled air flow 52 is supplied to the inlet guide vanes and rotor blades of the high pressure turbine 22 whilst the cooled air flow 62 is supplied to the inlet guide vanes and rotor blades of the intermediate pressure turbine 24.

The common mounting disc 58 is mounted on one or more bearings (not shown), being either a single bearing located at the front or back or a pair of bearings located at both ends of the re-pressurisation device 36. Preferably the bearings are air bearings, with the air being supplied, for example, from the cooled air flow 38 supplied to the re-pressurisation device 36. The air is passed from the front to the back of the re-pressurisation device 36, preferably through the centre of the disc 58, to supply a rear bearing and/or to be exhausted into the re-pressurised cooled air flow 52. This has the advantage of passing cooled air through the centre of the disc 58, which prevents a heat exchange taking place between the bearing air flow and the compressor stage air flow since there is little or no heat gradient between the flows. The bearing air can be exhausted into the re-pressurised cooled air flow 52 without resulting in a significant increase in heat or decrease in pressure of that flow. Hence the re-pressurisation device 36 produces two (or more) useful cooling flows and no waste flow so less air needs to be extracted to provide sufficient cooling of the hot parts of the engine than in the prior art. This means the engine can operate more efficiently by passing a greater volume of air in the core and bypass flows. Further, it can operate at higher temperatures since the hot parts are better cooled.

Various modifications to the described embodiment will be apparent to the skilled reader without departing from the scope of the claimed invention. For example, although the bearings have been described as air bearings they could alternatively be electromagnetic bearings or oil film bearings. The compressor stage has been described radially inwardly of the turbine stage but the advantages of the invention are equally achieved by positioning the compressor stage radially outwardly of the turbine stage.

A single stage compressor 42 is shown but a multi-stage compressor, comprising alternating rotors 50 and stators 48, may be beneficial in certain applications. A multi-stage compressor will add some weight to the re-pressurisation device 36 but will continue to derive the benefits of the lack of a shaft since further stages can be mounted on the flow director 44 or on an annular housing 64, being radially inwardly of the compressor stage 42.

Alternatively, additional stages may be mounted on a combination of the flow director 44 and the annular housing 64.

Alternatively both the compressor 42 and turbine 46 may comprise multiple stages. In this case the common mounting 58 could be a series of discs or a drum, which again removes the need for one or more shafts. Alternatively the additional stages may be mounted on the flow director 4.

Although the preferred embodiment of the present invention provides two cooled air flows for cooling hot parts of the engine, one re-pressurised 52 and one not 62, these flows could be recombined to provide a single flow for cooling. Alternatively, one or both of the flows 52, 62 could be split to cool more than one hot part of the engine, for example the high, intermediate and low pressure turbine stages 22, 24, 26.

The re-pressurisation device 36 and its preceding heat exchanger 34 are preferably located within the bypass duct 32. This is particularly advantageous because it means that bypass air is used as the coolant in the heat exchanger 34 and therefore no extra ducting is required to supply the coolant or exhaust the heated coolant after heat exchange between flows has occurred. However, the re-pressurisation device 36, with or without the heat exchanger 34, may alternatively be located in other parts of the engine. For example, it or they may be located radially inwardly of the bypass duct 32 and adjacent a compressor stage 16, 18. Alternatively, it or they may be located within the nacelle 30.

Although it is preferable to provide a heat exchanger 34 upstream of the re-pressurisation device 36 the advantages of the present invention may be obtained by using the re-pressurisation device 36 without a preceding heat exchanger 34.

Although the present invention has been described with reference to a three-shaft engine it is equally applicable to a two-shaft design.

The present invention has been described with reference to a gas turbine engine. However, it can be used in a range of other applications including air conditioning systems and combined cycle power generation.

I claim:

1. A gas turbine engine re-pressurisation device for cooled cooling fluid, the re-pressurisation device comprising a compressor stage and a turbine stage, characterised in that a common mounting means is provided between the compressor stage and the turbine stage such that one of the compressor stage and the turbine stage is located radially inwardly of the other, the re-pressurisation device further comprising fluid flow directing means to direct a first portion of the fluid through the compressor stage and a second portion through the turbine stage.

2. A re-pressurisation device as claimed in claim 1 wherein the turbine stage comprises at least one rotor stage comprising an annular array of rotor blades.

3. A re-pressurisation device as claimed in claim 1 wherein the turbine stage comprises at least one rotor stage and at least one stator stage comprising an annular array of stator vanes.

4. A re-pressurisation device as claimed in claim 3 wherein the turbine stage comprises rotor and stator stages in alternating relation.

5. A re-pressurisation device as claimed in claim 1 wherein the compressor stage comprises at least one rotor stage comprising an annular array of rotor blades.

6. A re-pressurisation device as claimed in claim 1 wherein the compressor stage comprises at least one rotor stage and at least one stator stage comprising an annular array of stator vanes.

7. A re-pressurisation device as claimed in claim 6 wherein the compressor stage comprises rotor and stator stages in alternating relation.

8. A re-pressurisation device as claimed in claim 1 wherein the compressor stage is a multi-stage compressor.

9. A re-pressurisation device as claimed in claim 1 wherein the common mounting means is a disc or drum.

10. A re-pressurisation device as claimed in claim 1 wherein the common mounting means is located by at least one bearing.

11. A re-pressurisation device as claimed in claim 10 wherein the or each bearing is one of the group comprising air bearings, electro-magnetic bearings and oil film bearings.

12. A re-pressurisation device as claimed in claim 1 wherein the compressor stage is located radially inwardly of the turbine stage.

13. A gas turbine engine comprising a re-pressurisation device as claimed in claim 1.

14. A gas turbine engine as claimed in claim 13 wherein the gas turbine engine further comprises a heat exchanger upstream of the re-pressurisation device.

15. A gas turbine engine as claimed in claim 13 wherein the cooled cooling fluid is air extracted from a bypass duct of the gas turbine engine.
